(19) United States
(12) Patent Application Publication
(10) Pub. No.: US 2008/0002429 A1
(43) Pub. Date: Jan. 3, 2008

(54) Backlight unit and display device with the backlight unit

(75) Inventor: Koya Noba, Fujiyoshida-shi (JP)

Correspondence Address: BRINKS HOFER GILSON & LIONE, P.O. BOX 10395, CHICAGO, IL, 60610, US

(73) Assignee: CITIZEN ELECTRONICS CO., LTD.

(21) Appl. No.: 11/824,294

(22) Filed: Jun. 28, 2007

(30) Foreign Application Priority Data
Jun. 29, 2006 (JP) JP2006-179002

(51) Int. Cl. F21V 8/00

(52) U.S. Cl. 362/612

(57) ABSTRACT

An edge-light type light guide plate has on a light-receiving surface thereof a multiplicity of light-diffusing surfaces of concave or convex cross-section that introduce incident light into the light guide plate while diffusing it. The light-diffusing surfaces can be shaped and arranged in a variety of ways. The light-diffusing surfaces preferably have a semicircular cross-section but may have a triangular or other cross-sectional configuration. Because light incident on the light-receiving surface is diffused, mixing of colors of light starts from a region close to the light-receiving surface. Accordingly, color irregularity of emitted light can be minimized.

This application claims priority under 35 U.S.C. §119 to Japanese Patent Application No. 2006-179002 filed Jun. 29, 2006, the entire content of which is hereby incorporated by reference.

### BACKGROUND OF THE INVENTION

1. Field of the Invention

The present invention relates to a light guide plate and devices related thereto.

2. Description of the Related Arts

Liquid crystal display devices have been widespread and used in medium- and large-sized apparatuses such as personal computers and liquid crystal television sets, and also in small-sized portable apparatuses such as cellular phones, and projectors (image projectors). Liquid crystal display devices used in these apparatuses generally have backlight units disposed behind their liquid crystal display panels to make the displayed image appear bright and sharp. Examples of illuminating light sources generally used for the backlight units are as follows: cold-cathode fluorescent tubes for liquid crystal display devices of medium- and large-sized apparatus; white LEDs (light-emitting diodes) for liquid crystal display devices of small-sized portable apparatus; and extra-high pressure mercury lamps for liquid crystal display devices of projectors.

In recent years, the application range of LEDs has expanded rapidly owing to the improvement in luminous efficiency thereof, and red, green and blue LEDs have become used as light sources for backlight units of liquid crystal display devices in products in which white LEDs, cold-cathode fluorescent tubes, or extra-high pressure mercury lamps have heretofore been used as light sources. One advantage of a backlight unit using a light source comprising red, green and blue LEDs is expansion of the color reproduction range of images displayed on the liquid crystal display panel. For example, it is possible to display dark red and green colors, which have heretofore been difficult with conventional image display systems.

FIGS. 22a and 22b show such a conventional backlight unit. The backlight unit has a light guide plate 1, LEDs 2 disposed adjacent to a light-receiving surface 1a of the light guide plate 1, and a substrate 3 having the LEDs 2 mounted thereon. Light from the LEDs 2 enters the light guide plate 1 through the light-receiving surface 1a and exits from a light-emitting surface 1c. A reflector comprising prisms or the like is provided on a lower surface 1d of the light guide plate 1 to reflect light entering the light guide plate 1 from the LEDs 2 toward the light-emitting surface 1c. Generally, a stack of a light-diffusing sheet and prism sheets is provided over the light-emitting surface 1c of the light guide plate 1, and a reflecting sheet is provided under the lower surface 1d thereof.

The LEDs 2 include, as shown in FIG. 22b, three different types of LEDs R, G and B, which emit red, green and blue colors of light, respectively.

If the red, green and blue LEDs 2 are turned on simultaneously, red, green and blue colors of light exiting the light-emitting surface 1c of the light guide plate 1 mix together to form white light. In actuality, however, color mixing takes place as shown schematically in FIG. 23. That is, white light is formed in a region C, but in a region D the mixing of red, green and blue colors of light may be insufficient, resulting in color irregularity.

Light emitted from an LED has directivity. That is, the emission intensity is the strongest in a direct front direction relative to the LED's light-emitting surface (i.e. in the direction normal thereto). The emission intensity becomes weaker as the angle from the direct front direction increases. Generally, nearly 90% of the light quantity falls in an angle range of 50 degrees from the direct front direction.

Let us assume that in FIG. 23 the direction of the X axis (abscissa axis) is the depth or the longitudinal direction of the light guide plate 1, and the direction of the Y axis (ordinate axis) is the width direction of the light guide plate 1. If the red, green and blue LEDs 2 are arranged as shown in FIG. 23, the red, green and blue colors of light diffuse as they travel in the X direction in the light guide plate 1 and mix well together, so that uniform white light can be obtained in the region C.

In the region D, which is closer to the light-receiving surface 1a, the red, green and blue colors of light have not yet well diffused. Consequently, the mixing of the above-described three colors of light is not sufficient, and color irregularity appears on the light-emitting surface 1c.

In a case where a light-diffusing sheet and prism sheets are provided at the light-emitting surface side of the light guide plate, light emitted from the light-emitting surface of the light guide plate is adjusted through the light-diffusing sheet and the prism sheets before exiting the light-emitting surface of the backlight unit. In this case, even a portion of the light-emitting surface of the backlight unit that appears white when viewed from a position directly in front of it may appear as having color irregularity when viewed from a position obliquely in front thereof because the light source colors of light from the red, green and blue LEDs 2 are emitted therefrom as they are unmixed. This means that the three colors of light from the LEDs 2 have not yet sufficiently mixed together even at the stage when they have reached the light-emitting surface of the backlight unit.

With regard to the above-described technical problem, another type of planar light source (backlight unit) has been proposed as disclosed in Japanese Patent Application Publication No. 2005-183124. The planar light source has, as shown in FIG. 24, red, green and blue light-emitting linear light sources 12R, 12G and 12B mounted on a substrate 13 positioned in parallel to the light-receiving surface. Each of the linear light sources comprises a plurality of red, green or blue LEDs spaced apart from each other in the width direction of the light-receiving surface of the lightguide plate and a linear reflector disposed behind the LEDs for uniformly reflecting light from the LEDs towards the light-receiving surface of the lightguide plate. Taking into account difference in the light strengths of the red LED, the green LED and the blue LED, the number of the LEDs of the respective liner light sources are adjustably made different from each other so as to perform appropriate mixing of the three different colors of light. Thus, in this backlight unit, the red, green and blue LEDs are not aligned with each other in a plane normal to the light-receiving surface and the light-emitting surface of the lightguide plate.

According to this proposal, it is stated that the linear light sources are arranged to achieve uniformity of light illuminating the light receiving-surface of the lightguide plate in the width direction thereof and, further, they are arranged very close to each other in the vertical direction to attain mixing in the vertical direction of the three colors of light from the light sources, thereby eliminating color irregularity of light emitted from the backlight unit.

However, as shown in FIG. 25, light emitted from the linear light sources 12R, 12G and 12B enter the light guide plate 11 and travel therein while being refracted at the light-receiving surface 11a in the converging direction. Accordingly, the mixing of the three colors of light from the linear light sources 12R, 12G and 12B in the vertical direction starts from a distance L₂ spaced farther apart from the light-receiving surface 11a as shown in FIG. 25, resulting in a region E where the three colors of light are mixed together as shown by oblique lines, and a region F where no color mixing takes place. Further, because light from the linear light sources 12R, 12G and 12B are refracted in the converging direction as they enter the light guide plate 11 and travel therein, in a region very close to the light-receiving surface 11a, the amount of light incident on a reflecting surface 11b on the bottom of the light guide plate 11 and a reflecting sheet provided at the lower side of the light guide plate 11 reduces and hence the amount of reflected light therefrom also reduces. Accordingly, sufficient color mixing cannot be attained in the region very close to the light-receiving surface 11a, and color irregularity occurs in this region. The occurrence of the color irregularity is unavoidable because there is a limit to the reduction of the spacings between the linear light sources 12R, 12G and 12B.

It is necessary for the backlight unit illuminating a liquid crystal display panel to be designed so that a region thereof where color irregularity appears is placed outside the display area of the liquid crystal display panel. This limits the downsizing of the backlight unit.

### SUMMARY OF THE INVENTION

The present invention has been made in view of the above-described circumstances. Accordingly, an object of the present invention is to minimize color irregularity appearing on the light-emitting surface of a light guide plate and that of a backlight unit.

According to one aspect thereof, the present invention provides a backlight unit including a light guide plate. The light guide plate has a light-emitting surface, an opposite surface opposite to the light-emitting surface, and a peripheral edge surface extending between the peripheral edges of the light-emitting surface and the opposite surface. A part of the peripheral edge surface is a flat light-receiving surface substantially at right angles to the light-emitting surface. The light-receiving surface has a plurality of concave or convex light-diffusing surfaces that introduce incident light into the light guide plate while diffusing it. The backlight unit further includes a plurality of light-emitting diodes disposed in a plane substantially at right angles to both the light-receiving surface and the light-emitting surface. The light-emitting diodes irradiate the light-receiving surface with respective light of radiation spectra having different peak output wavelengths.

In this backlight unit, the concave or convex light-diffusing surfaces refract incident light and introduce it into the light guide plate while diffusing it. Therefore, the mixing of colors of light entering through the light-receiving surface starts from a region close to the light-receiving surface. Accordingly, color irregularity on the light-emitting surface can be minimized. Generally, a reflector comprising prisms or the like is provided on the above-described opposite surface of the light guide plate. When such a reflector is present, light diffused by the light-diffusing surfaces is incident on and reflected by the reflector near the light-receiving surface. Therefore, the mixing of colors of light near the light-receiving surface is promoted, so that color irregularity can be further minimized. Further, because a plurality of light-emitting diodes that irradiate the light-receiving surface with respective light of radiation spectra having different peak output wavelengths are disposed in the above-described plane, the colors of light emitted from these light-emitting diodes can be mixed efficiently.

Specifically, the light-emitting diodes may be arranged successively in a direction from the opposite surface toward the light-emitting surface and opposed to the light-receiving surface.

As specific examples of the above, the light-emitting diodes may be disposed along an axis inclined with respect to the light-receiving surface in the above-described plane. Alternatively, at least two of the light-emitting diodes may be disposed at different distances from the light-receiving surface and opposed to said light-receiving surface.

In either case, the light-emitting diodes are disposed at different distances from the light-receiving surface. In this regard, the light-emitting diodes should preferably be disposed properly in consideration of the intensity of light emitted from the light-emitting diodes so that appropriate color mixing can be performed.

The light-diffusing surfaces may be adapted to diffuse light in the thickness direction of the light guide plate.

This enables color mixing in the above-described plane to be performed even more efficiently.

Specifically, the light-diffusing surfaces may be provided along mutually parallel imaginary lines extending in the width direction of the light-receiving surface.

The light-diffusing surfaces may be provided continuously or discontinuously along the imaginary lines.

The light-diffusing surfaces may have a substantially semicircular or triangular cross-section, respectively.

The light-diffusing surfaces may include a plurality of mutually parallel first elongated surfaces having a concave cross-section and a plurality of mutually parallel second elongated surfaces of concave cross-section that intersect the first elongated surfaces.

The light-emitting diodes may be mounted on respective substrates. Mounting the light-emitting diodes on respective substrates is advantageous in layout and installation of the light-emitting diodes.

The light-emitting diodes may include light-emitting diodes having peak output wavelengths in a red region, a green region, and a blue region, respectively. These light-emitting diodes are disposed in the above-described area, and light from the light-emitting diodes are incident on the light-receiving surface having the light-diffusing surfaces. Therefore, color mixing can be performed efficiently, and it is possible to emit white light with minimized color irregularity.

The light-emitting diodes may include whitish light-emitting diodes that are blue light-emitting diodes coated with a fluorescent material. The use of such whitish light-emitting diodes enables generation of white light without the need to prepare the above-described light-emitting diodes for three colors. Therefore, the backlight unit can be downsized.

The light guide plate may comprise a plurality of split light guide plates that are tabular and stacked in a direction from the opposite surface toward the light-emitting surface. With this arrangement, refraction and diffusion of light occur between the adjacent split light guide plates. Thus, diffusion of light in the light guide plate is further promoted.

In this case, parts of the peripheral edge surfaces of the split light guide plates that cooperate to form the light-receiving surface of the light guide plate may be disposed in the same plane.

Further, the light-emitting diodes may be disposed to correspond respectively to the split light guide plates.

According to another aspect thereof, the present invention provides a display device including the above-described backlight unit and a liquid crystal display panel disposed adjacent to the light-emitting surface of the backlight unit.

The above-described backlight unit has minimum color irregularity on the light-emitting surface and provides an enlarged area for emitting uniformly mixed colors of light. Accordingly, the display surface area can be enlarged.

The above and other objects, features and advantages of the present invention will become more apparent from the following description of the preferred embodiments thereof, taken in conjunction with the accompanying drawings.

### BRIEF DESCRIPTION OF THE DRAWINGS

FIG. 1 is a perspective view of a light guide plate according to a first embodiment of the present invention.

FIG. 2 is a fragmentary sectional view of an essential part of the light guide plate shown in FIG. 1.

FIG. 3 is an explanatory view schematically showing the action of light-diffusing surfaces of the light guide plate in FIG. 1.

FIG. 4 is an explanatory view schematically showing the functional relationship between the layout of light-emitting diodes and the light guide plate.

FIG. 5a is a diagram showing an example in which parallel linear light-diffusing surfaces are inclined with respect to a light-emitting surface of the light guide plate.

FIG. 5b is a diagram showing an example in which linear light-diffusing surfaces intersect each other in a mesh pattern.

FIG. 6a is a diagram showing an example in which mutually spaced short linear light-diffusing surfaces are provided in rows.

FIG. 6b is a diagram showing an example in which a multiplicity of mutually spaced dot-shaped light-diffusing surfaces are provided in rows.

FIG. 7a is a diagram showing a modification of the light guide plate.

FIG. 7b is a diagram showing another modification of the light guide plate.

FIG. 8 is a side view of a display device according to the present invention.

FIG. 9 is a plan view of a light guide plate and light-emitting diodes of the display device in FIG. 8 as seen from the liquid crystal display panel side.

FIG. 10 is a sectional view taken along the line 10-10 in FIG. 9.

FIG. 11 is a perspective view schematically showing the light guide plate and the light-emitting diodes of the display device in FIG. 8.

FIG. 12 is a side view of a display device having a backlight unit according to a third embodiment of the present invention.

FIG. 13 is a plan view of the backlight unit of the display device in FIG. 12.

FIG. 14 is a diagram showing the relationship between a light guide plate and a light source unit of the display device in FIG. 12.

FIG. 15a is a side view showing another example of the layout of three different types of light-emitting diodes, i.e. red, green and blue light-emitting diodes.

FIG. 15b is a side view showing still another example of the layout of red, green and blue light-emitting diodes.

FIG. 16 is a side view showing the layout of a light source unit and a light guide plate of a backlight unit according to a further embodiment of the present invention.

FIG. 17 is a side view showing the layout of a light source unit and a light guide plate of a backlight unit according to a still further embodiment of the present invention.

FIG. 18 is a side view showing the layout of a light source unit and a light guide plate of a backlight unit according to a still further embodiment of the present invention.

FIG. 19 is a perspective view of a light guide plate of a backlight unit according to a still further embodiment of the present invention.

FIG. 20 is a plan view showing the positional relationship between the light guide plate in FIG. 19 and a light source unit.

FIG. 21 is a side view of the light source unit and the light guide plate in FIG. 20.

FIG. 22a is a side view showing an example of the layout of a conventional light guide plate and red, green and blue light-emitting diodes.

FIG. 22b is a plan view of FIG. 22a.

FIG. 23 is an explanatory view schematically showing the way in which color irregularity occurs when the red, green and blue light-emitting diodes in FIGS. 22a and 22b are turned on simultaneously.

FIG. 24 is a side view of a planar light source according to another related art.

FIG. 25 is an explanatory view illustrating the action of guiding light from the planar light source shown in FIG. 24.

### DESCRIPTION OF THE PREFERRED EMBODIMENTS

Embodiments of the present invention will be described below with reference to the accompanying drawings.

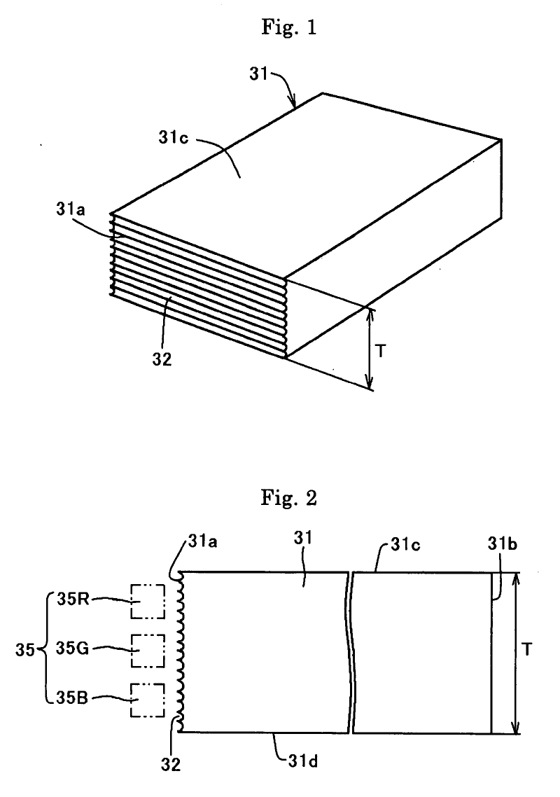

FIGS. 1 to 7b show a light guide plate 31 according to a first embodiment of the present invention.

The light guide plate 31 is, as shown in FIGS. 1 and 2, quadrangular as seen in a plan view and has a thickness T. The light guide plate 31 receives light from LEDs 35 through a light-receiving surface 31a and emits it from a light-emitting surface 31c while guiding the received light toward an opposite surface 31b opposite to the light-receiving surface 31a. The LEDs 35 include red LEDs 35R, green LEDs 35G, and blue LEDs 35B. The illustrated layout of the LEDs 35 is merely an example and should not necessarily be construed as restrictive. Further, the LEDs 35 are not necessarily limited to the LEDs emitting three colors of light, i.e. red, green, and blue. LEDs emitting one or two different colors of light are also applicable.

As shown in FIGS. 1 and 2, the light-receiving surface 31a of the light guide plate 31 has a plurality of elongated light-diffusing surfaces 32 of concave cross-section extending parallel to each other in the width direction of the light-receiving surface 31a. In the illustrated example, the cross-section of the light-diffusing surfaces 32 is semicircular and has a width of several μm to several tens of μm. In the figures, however, the light-diffusing surfaces 32 are shown exaggeratedly large for the sake of clarity. Although not shown in the figures, a reflector comprising prisms or the like is provided on a lower surface 31d opposite to the light-emitting surface 31c.

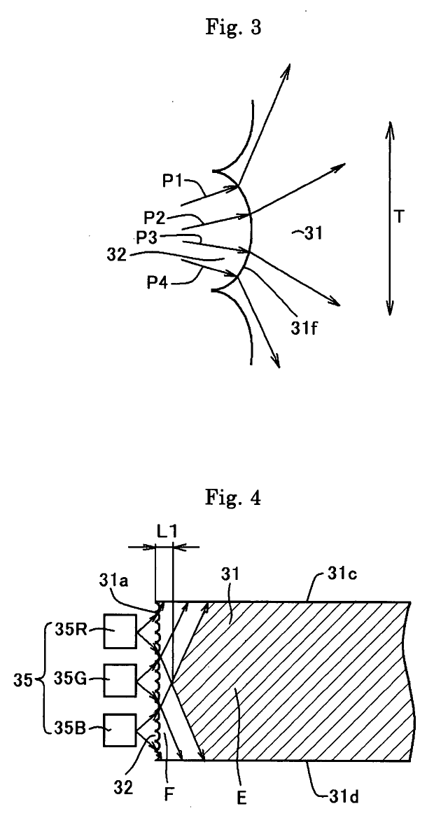

As shown in FIGS. 3 and 4, lights P₁, P₂, P₃ and P₄ incident on the surface 31f of each light-diffusing surface 32 are refracted and diffused in the thickness direction of the light guide plate 31.

The cross-section of the light-diffusing surfaces 32 may have any configuration that diffuses light by refraction. Therefore, the cross-section of the light-diffusing surfaces 32 may have a semicircular or triangular configuration or a mixture of these configurations. It is, however, preferable for the cross-section to have a gently curved surface configuration such as a semicircular or semielliptical configuration. The term “semicircular configuration” used in this specification means to include semicircular and semielliptical configurations. The light guide plate 31 is preferably injection-molded by using a resin material such as an acrylic resin, or a polycarbonate resin. Because the semicircular or triangular cross-section is a simple configuration, a mold for the injection molding is easy to make, and the injection molding process can be performed easily.

The light-diffusing effect can be controlled by varying the radius of curvature of the light-diffusing surfaces 32. For example, if the radius of curvature is increased, the light-diffusing effect decreases. If the curvature radius is reduced, the light-diffusing effect increases. In a case where the light-diffusing surfaces 32 are formed with a triangular cross-section, if the angle formed between two slant surfaces of the triangular cross-section is increased, the light-diffusing effect decreases. If the angle is reduced, the light-diffusing effect increases.

As shown in FIG. 4, three colors (red, green and blue) of light from the LEDs 35R, 35G and 35B are refracted by the light-diffusing surfaces 32 provided on the light-receiving surface 31a of the light guide plate 31. Thus, the three colors of light are diffused at a wide angle in the thickness direction as they travel in the light guide plate 31. Consequently, mixing of the three colors of light, e.g. red, green and blue light, starts from a distance L₁ very close to the light-receiving surface 31a. Further, the three colors (red, green and blue) of light are also incident on the reflector comprising prisms or the like on the lower surface 31d. Light passing through the reflector on the lower surface 31d is incident on a reflecting sheet (not shown) provided at the lower side of the light guide plate 31. Light reflected from the reflector on the lower surface 31d and light reflected from the reflecting sheet travel in the light guide plate 31 again. Therefore, even at a position very close to the light-receiving surface 31a, red, green and blue colors of light satisfactorily diffuse and mix together and then exit outward from the light-emitting surface 31c if the angle of incidence thereon is smaller than the critical angle. Accordingly, even at a position very close to the light-receiving surface 31a, an increased amount of light is emitted as white light generated by mixing of the three colors, i.e. red, green and blue. In FIG. 4, a region E shown by oblique lines is where the red, green and blue colors of light mix together, and a region F is where such color mixing does not sufficiently take place. The provision of the light-diffusing surfaces 32 markedly increases the area where white light is emitted from the light-emitting surface 31c.

If, however, the light-diffusing effect by the light-diffusing surfaces 32 is extremely increased, it may become impossible for a sufficient amount of light to reach the inner part of the light guide plate 31. Therefore, it is preferable to adjust the light-diffusing effect of the light-diffusing surfaces 32 so that a uniform amount of light is emitted from the entire area of the light-emitting surface 31c.

Generally, an edge-light type backlight unit has a reflecting sheet at the lower side of a light guide plate and has a stack of a diffusing sheet and prism sheets at the upper side of the light guide plate. Light exiting the light guide plate is diffused by the diffusing sheet, and only light that satisfies the transmission conditions for the prism sheets passes through the prism sheets as exiting light from the backlight unit. Thus, light exiting the light-emitting surface 31c of the light guide plate 31 as a mixture of three colors of light, i.e. red, green and blue, is further diffused by the diffusing sheet. Therefore, white light substantially free from color irregularity is emitted from the light-emitting surface (light output surface) of the backlight unit.

A verification test was performed on a backlight unit using 75 sets of red, green and blue LEDs which are vertically aligned each other for a 14-inch size light guide plate, the sets of the LEDs being arranged in the width direction of the light receiving surface. The result of the verification test is as follows. The center luminance of the light-emitting surface was about 3,000 cd/m². The luminance uniformity of the light-emitting surface was about 80%. When the chromaticity of various areas in the light-emitting surface was measured relative to the chromaticity of the center of the light-emitting surface, chromaticity differences of less than ±0.01 were obtained. The result reveals that the backlight unit is free from visible color irregularity and provides uniform white light. As a comparative example, a verification test was performed on a backlight unit that was not provided with light-diffusing surfaces 32. With this backlight unit, chromaticity differences of about ±0.02 to 0.05 were found, and color irregularity was clearly visible by visual inspection.

The backlight unit is placed behind a display panel in actual use. In this regard, if the area of the backlight unit that provides white light increases, the image display area of the display panel can be increased correspondingly. The image display area of the display panel is substantially set by product specifications. Therefore, the backlight unit can be downsized, provided that the image display area remains unchanged.

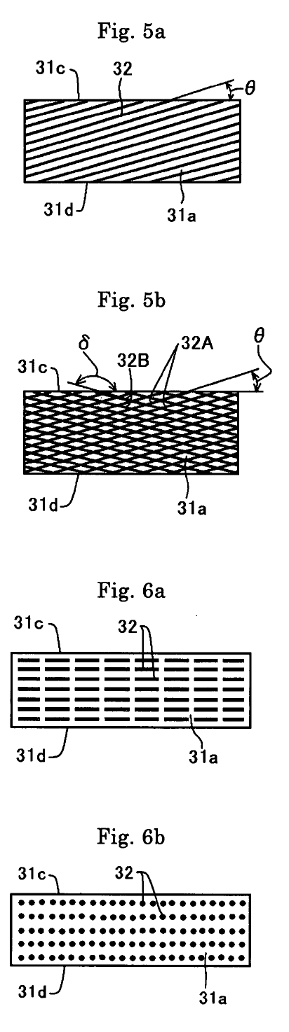

FIGS. 5a and 5b show modifications of the layout of the light-diffusing surfaces 32. It should be noted that in the embodiments and modifications described in this specification mutually corresponding constituent elements shall have substantially the same structures and functions unless otherwise specified.

The light-diffusing surfaces 32 shown in FIG. 5a are inclined at an angle θ to the light-emitting surface 31c. The light-diffusing surfaces 32 having the inclination angle θ refract light incident thereon with directivities in both the thickness and width directions of the light guide plate. If the inclination angle θ is small, the light-diffusing effect in the thickness direction is larger than in the width direction. Conversely, if the inclination angle θ increases, the light-diffusing effect in the width direction increases. The inclination angle θ should preferably be not larger than 45 degrees because the present invention aims at enhancing the light-diffusing effect in the thickness direction.

FIG. 5b shows a modification in which light-diffusing surfaces 32A that ascend as seen in the figure and descending light-diffusing surfaces 32B are arranged to intersect each other. The light-diffusing surfaces 32A are at an inclination angle θ to the light-emitting surface 31c. The light-diffusing surfaces 32B are at an inclination angle δ. The provision of the light-diffusing surfaces 32A and 32B in this way allows well-balanced light diffusion in both the thickness and width directions of the light guide plate.

Although in the foregoing description the light-diffusing surfaces 32 have been shown in the shape of straight continuous lines, the light-diffusing surfaces 32 are not necessarily limited to such a continuous line shape.

For example, FIG. 6a shows short, straight line-shaped light-diffusing surfaces 32 provided at regular spacings in the width direction of the light guide plate. FIG. 6b show light-diffusing surfaces 32 comprising dot-shaped recesses provided at regular spacings in the width direction of the light guide plate. The dot-shaped light-diffusing surfaces 32 diffuse light not only in the thickness direction but also in the width direction. The light-diffusing surfaces 32 shown in FIGS. 6a and 6b may be provided along imaginary lines inclined with respect to the light-emitting surface 31c as shown in FIGS. 5a and 5b.

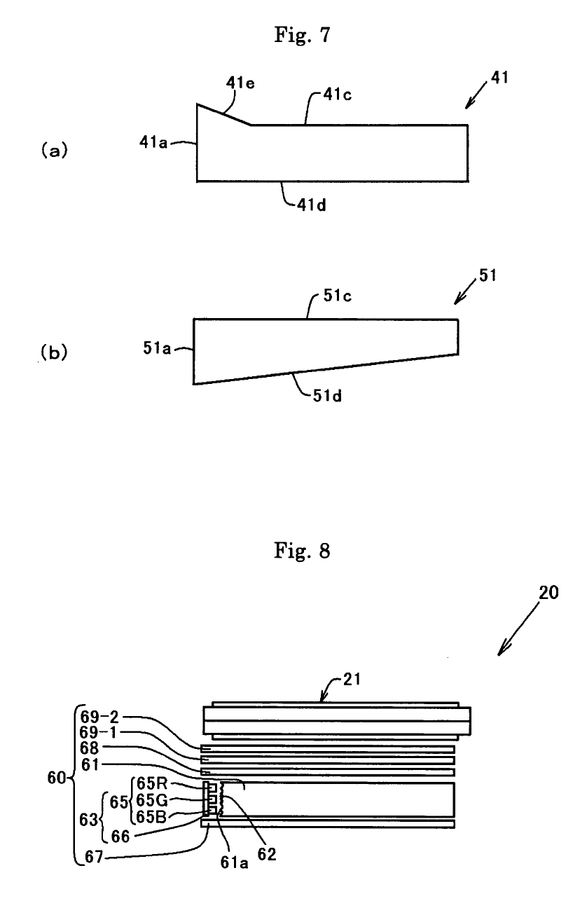

Light guide plates to which the present invention is applicable are not necessarily limited to flat plate-shaped ones. For example, a light guide plate 41 shown in FIG. 7a has a light-receiving surface 41a extending upward beyond a light-emitting surface 41c thereof. A slant surface 41e is adapted to reflect light entering the light guide plate 41 toward the inner part thereof. A bottom surface 41d is provided with a reflector comprising prisms or the like. A light guide plate 51 shown in FIG. 7b has a light-emitting surface 51c and a lower surface 51d opposite thereto. The lower surface 51d is inclined with respect to the light-emitting surface 51c. The term “tabular” as used in this specification means to include such configurations as those of the light guide plates 41 and 51.

In the embodiment shown in FIGS. 1 and 2, light is received from one side surface of the light guide plate. In some medium- and large-sized light guide plates, however, light is received from two opposite side surfaces thereof. The present invention is also applicable in such cases.

Next, a display device 20 shown in FIGS. 8 to 11 will be explained.

The display device 20 has a liquid crystal display panel 21 and a backlight unit 60 provided behind the liquid crystal display panel 21. The liquid crystal display panel 21 is an active-matrix display panel that has a liquid crystal material sealed in between a pair of substrates (upper and lower) and that has a large number of TFT (thin film transistor) display pixels formed thereon. The display pixels are provided with color filters of red (R), green (G) and blue (B). The upper surface of the upper substrate is provided with a polarizer. Similarly, the lower surface of the lower substrate is provided with a polarizer.

The backlight unit 60 comprises a stack of a reflecting sheet 67, a light guide plate 61, a diffusing sheet 68, and two prism sheets 69-1 and 69-2, which are stacked up from bottom to top. The backlight unit 60 has a light source unit 63 at one side surface of the light guide plate 61. The light source unit 63 has three different types of LEDs 65 mounted on a mounting substrate 66. The LEDs 65 include red LEDs 65R, green LEDs 65G, and blue LEDs 65B.

The reflecting sheet 67 of the backlight unit 60 has a reflecting surface formed by vapor deposition of aluminum, for example, on a resin sheet. The reflecting sheet 67 reflects light coming out of the light guide plate 61 back thereinto. The diffusing sheet 68 is formed by dispersing fine silica particles into a transparent resin and forming it into a sheet. The diffusing sheet 68 diffuses light exiting a light-emitting surface 61c of the light guide plate 61. The two prism sheets 69-1 and 69-2 are each provided with a multiplicity of parallel elongated prisms and are arranged so that the extension directions of their respective prisms perpendicularly intersect each other. Thus, light passing through the prism sheets 69-1 and 69-2 is allowed to impinge substantially perpendicularly on the liquid crystal display panel 21, thereby increasing the luminous intensity for illuminating the liquid crystal display panel 21.

The light guide plate 61 is in a quadrangular flat plate shape and has a light-receiving surface 61a that receives light from the LEDs 65, an opposite surface 61b opposite to the light-receiving surface 61a, a light-emitting surface 61c facing the diffusing sheet 68, and a lower surface 61d opposite to the light-emitting surface 61c. The light-receiving surface 61a of the light guide plate 61 is provided with a plurality of concave elongated light-diffusing surfaces 62 of semicircular cross-section extending parallel to the light-emitting surface 61c in the same way as in the foregoing embodiment.

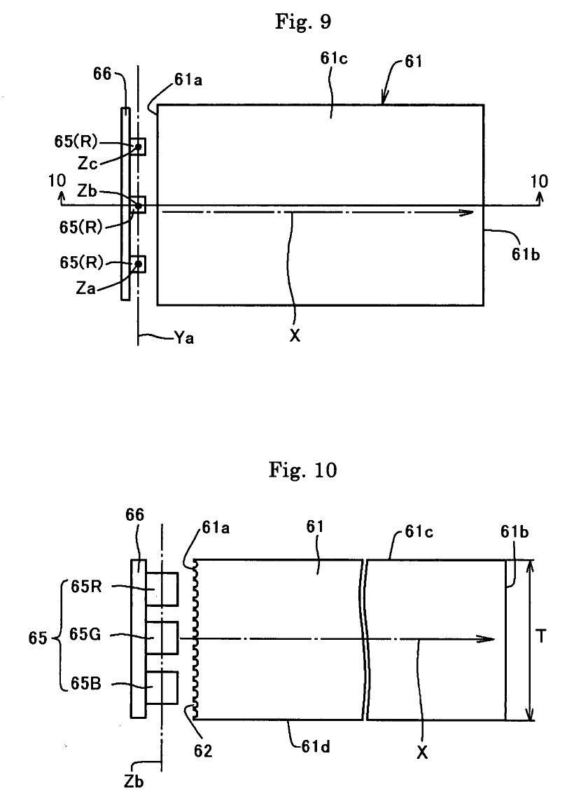

The LEDs 65 include red LEDs 65R, green LEDs 65G and blue LEDs 65B that are aligned in the vertical direction in the same way as in the embodiment shown in FIGS. 1 and 2. In the example shown in FIG. 9, three sets of LEDs 65R, 65G and 65B of three colors are provided along vertically extending axes Zₐ, Z_{b} and Z_{c} spaced from each other in the width direction of the light guide plate 61. The red LED 65R, the green LED 65G and the blue LED 65B of each set are arranged in the order shown in FIG. 10. The axes Zₐ, Z_{b} and Z_{c} are at equidistant positions from the light-receiving surface 61a. The red LEDs 65R provided on the axes Zₐ, Z_{b} and Z_{c} are aligned together along an axis Yₐ extending perpendicular to the axes Zₐ, Z_{b} and Z_{c}. The blue and green LEDs 65B and 65G are also aligned along respective axes parallel to the axis Yₐ. The spacings between the axes Zₐ, Z_{b} and Z_{c} should be appropriately set so that light from LEDs adjacent to each other in the width direction of the light guide plate 61 sufficiently mix together even in very close vicinity to the light-receiving surface 61a. The spacings between the red, green and blue LEDs stacked in three rows should be minimized so that light emitted vertically from the LEDs are mixed together sufficiently by the action of the light-diffusing surfaces 62 even in a region very near the light-receiving surface 61a. It should be noted that the arrow X in the figures indicates the direction of guiding light entering the light guide plate 61.

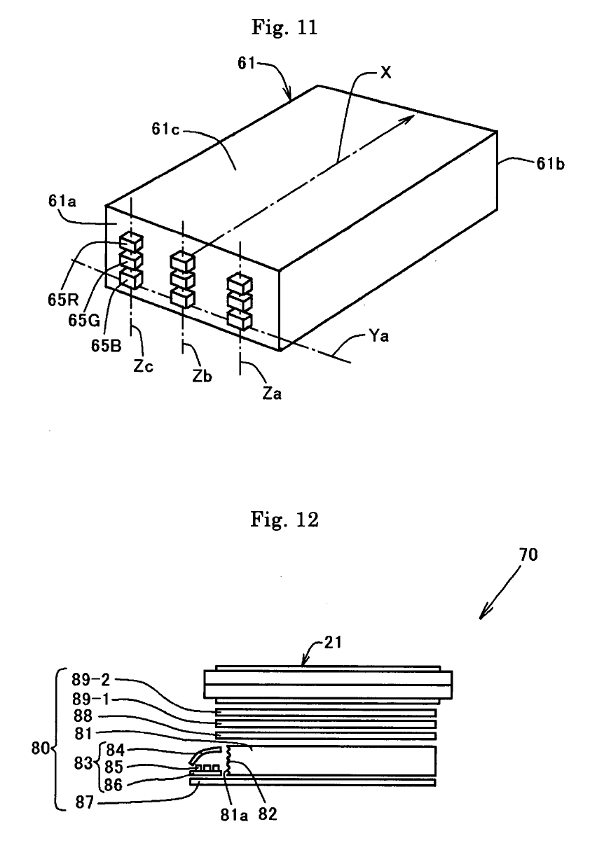

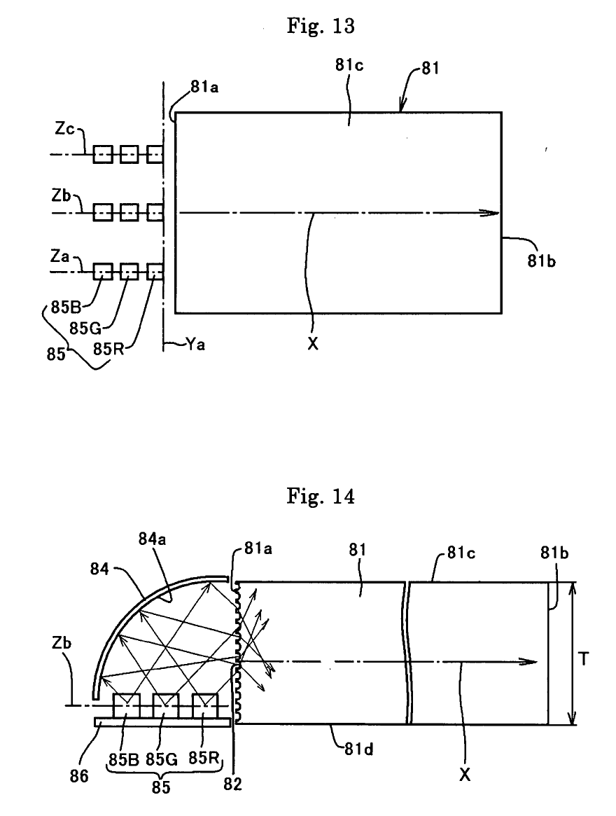

Next, a display device 70 shown in FIGS. 12 to 14 will be explained.

The display device 70 has a liquid crystal display panel 21 and a backlight unit 80. The backlight unit 80 comprises a stack of a reflecting sheet 87, a light guide plate 81, a diffusing sheet 88, and two prism sheets 89-1 and 89-2, which are stacked up from bottom to top. A light source unit 83 is provided adjacent to one side surface of the light guide plate 81. The light source unit 83 has, as shown in FIG. 14, LEDs 85 mounted on a mounting substrate 86 and a reflecting member 84. The LEDs 85 include three different types of LEDs, i.e. red LEDs 85R, green LEDs 85G, and blue LEDs 85B. The LEDs 85 emit light directly upward, and the emitted light is reflected by the reflecting member 84 toward a light-receiving surface 81a of the light guide plate 81.

The reflecting sheet 87, the diffusing sheet 88, the two prism sheets 89-1 and 89-2, and the light guide plate 81 are substantially the same as those shown in FIG. 8. Therefore, a detailed description thereof is omitted herein.

Three sets of red, green and blue LEDs 85R, 85G and 85B are provided in the order shown in the figures along axes Zₐ, Z_{b} and Z_{c} extending from the light-receiving surface 81a of the light guide plate 81 at right angles thereto. In the illustrated example, the axes Zₐ, Z_{b} and Z_{c} are spaced from each other in the width direction of the light guide plate 81. The red LEDs 85R provided on the axes Zₐ, Z_{b} and Z_{c} are aligned together along an axis Yₐ perpendicularly intersecting the axes Zₐ, Z_{b} and Z_{c} in parallel to a light-emitting surface 81c of the light guide plate 81. The blue and green LEDs 85B and 85G are also aligned along respective axes parallel to the axis Yₐ.

The reflecting member 84 is formed from a metal sheet or resin film having a reflecting surface 84a of high reflectance. Although in the illustrated example the reflecting member 84 has a curved reflecting surface, a flat plate-shaped reflecting member is also usable.

Red, green and blue colors of light emitted from the LEDs 85 are reflected by the reflecting member 84 before entering the light guide plate 81. In the optical path from the LEDs 85 to the light-receiving surface 81a, the three colors of light mix together to a certain extent. Accordingly, even at a region of the light-emitting surface 81c very close to the light-receiving surface 81a, the red, green and blue colors of light mix together to provide an increased amount of white light. Consequently, white light can be emitted from substantially the entire area of the light-emitting surface 81c. Light exiting the light-emitting surface 81c of the light guide plate 81 is further diffused by the action of the diffusing sheet 88 provided at the light-emitting surface 81c side of the light guide plate 81. Thus, white light substantially free from color irregularity is emitted from the light-emitting surface of the backlight unit 80.

Because the LEDs 85 are arranged in a planar array, the light guide plate 81 can be reduced in thickness and hence the thickness of the backlight unit 80 can be reduced. Therefore, when using relatively thick LEDs, it is preferable to arrange them in a planar fashion as in this embodiment.

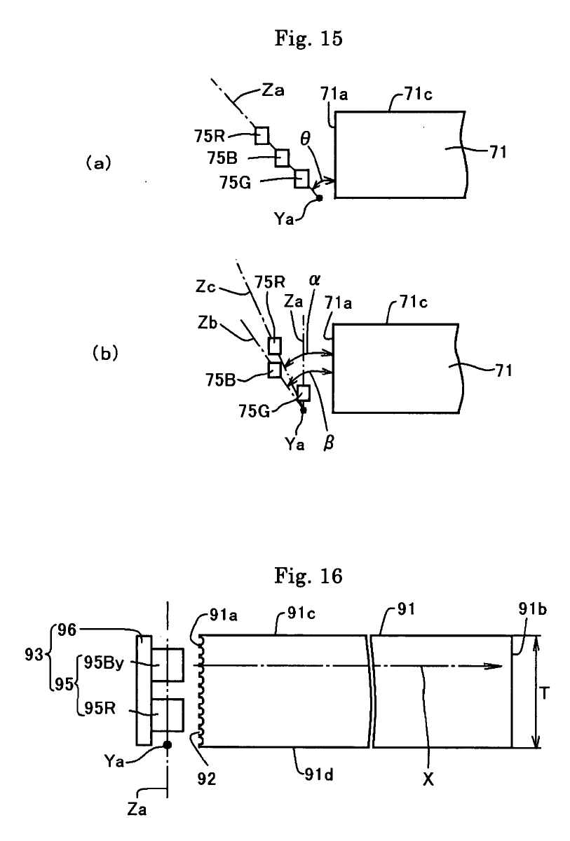

LEDs can be arranged in various layouts. For example, FIG. 15a shows an example in which a set of a green LED 75G, a blue LED 75B and a red LED 75R is disposed on an inclined axis Zₐ extending obliquely upward from a first axis Yₐ in a plane perpendicularly intersecting a light-receiving surface 71a. FIG. 15b shows an example in which a green LED 75G, a blue LED 75B and a red LED 75R are disposed on respective axes Zₐ, Z_{b} and Z_{c} extending from the axis Yₐ at different angles thereto.

Next, a backlight unit shown in FIG. 16 will be explained.

In this backlight unit, a light source unit 93 has LEDs 95 mounted on a mounting substrate 96. The LEDs 95 include red LEDs 95R and whitish LEDs 95By. Each whitish LED 95By is formed by packaging a blue light-emitting diode with a transparent resin having a yellow (YAG: yttrium aluminum garnet) fluorescent material dispersed therein. In the whitish LED 95By, the yellow fluorescent particles are excited to fluoresce by blue light emitted from the blue light-emitting diode, whereby whitish light is obtained. The whitish light from the whitish LEDs 95By is mixed with light from the red LEDs 95R. Thus, whitish light including an emission wavelength in the red region is obtained. This produces the effect of expanding the color reproduction range of color images displayed on the liquid crystal display panel. Fluorescent materials usable in the present invention are not necessarily limited to yellow ones. Green fluorescent materials or the like are also usable. Examples of usable green fluorescent materials are phosphate, silicate and aluminate fluorescent materials.

This backlight unit requires only two different types of LEDs and hence enables the thickness T of the light guide plate 91 to be reduced correspondingly and also allows a reduction in the number of man-hours needed to assemble the light source unit 93.

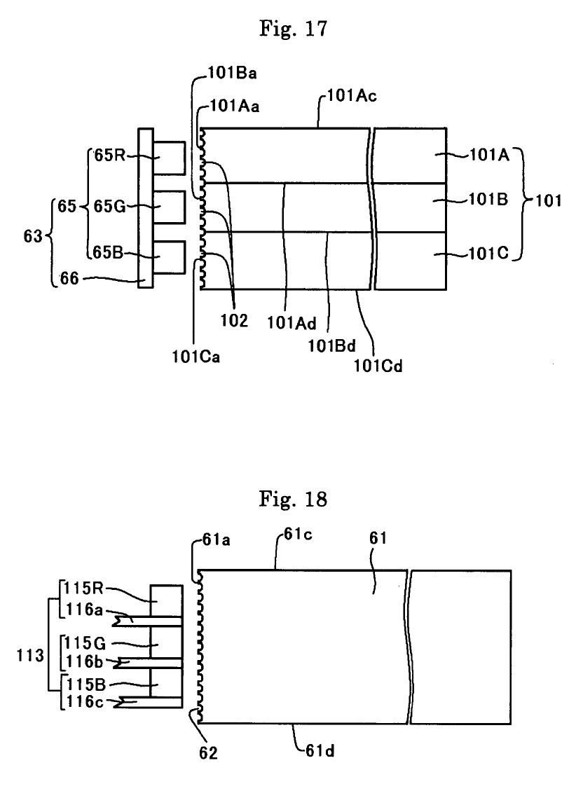

FIG. 17 shows a backlight unit according to a still further embodiment of the present invention.

This backlight unit has a light guide plate 101 comprising a stack of three split light guide plates 101A, 101B and 101C. Red LEDs 65R, green LEDs 65G and blue LEDs 65B are disposed to correspond respectively to the split light guide plates 101A, 101B and 101C. Each split light guide plate is substantially the same as the light guide plate in the foregoing embodiments. Light-diffusing surfaces 102 are provided on each of light-receiving surfaces 101Aa, 101Ba and 101Ca of the split light guide plates 101A, 101B and 101C. A reflector comprising prisms or other rugged structure is provided on each of lower surfaces 101Ad, 101Bd and 101Cd of the split light guide plates 101A, 101B and 101C. Thus, an air layer is present between each pair of adjacent split light guide plates. Therefore, light passing from one of the adjacent split light guide plates to the other undergoes refraction. Accordingly, the light-diffusing effect of the light guide plate 101 is enhanced, thereby promoting the mixing of red, green and blue colors of light from the LEDs 65, and thus increasing the effect of preventing the occurrence of color irregularity.

FIG. 18 shows a backlight unit according to a still further embodiment. In this backlight unit, red LEDs 115R, green LEDs 115G and blue LEDs 115B of a light source 113 are mounted on respective mounting substrates 116a, 116b and 116c. In this embodiment, side-lighting type LEDs are used. Because the red LEDs 115R, the green LEDs 115G and the blue LEDs 115B are mounted on the respective mounting substrates 116a, 116b and 116c, they are easy to lay out and install.

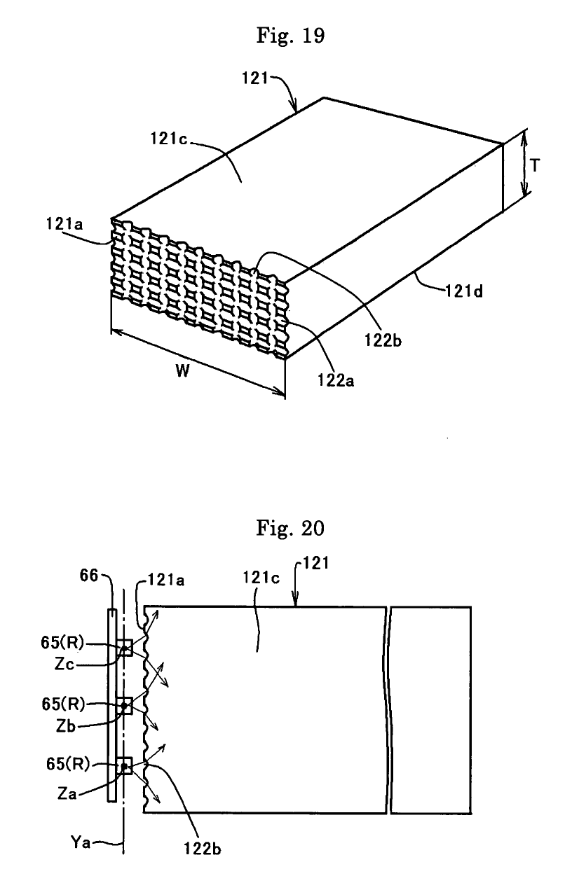

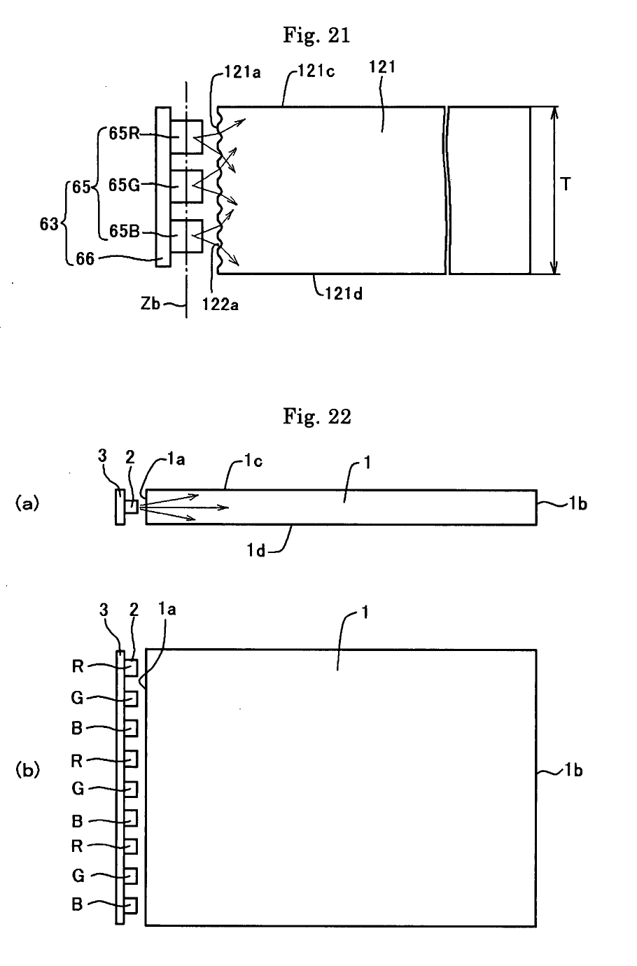

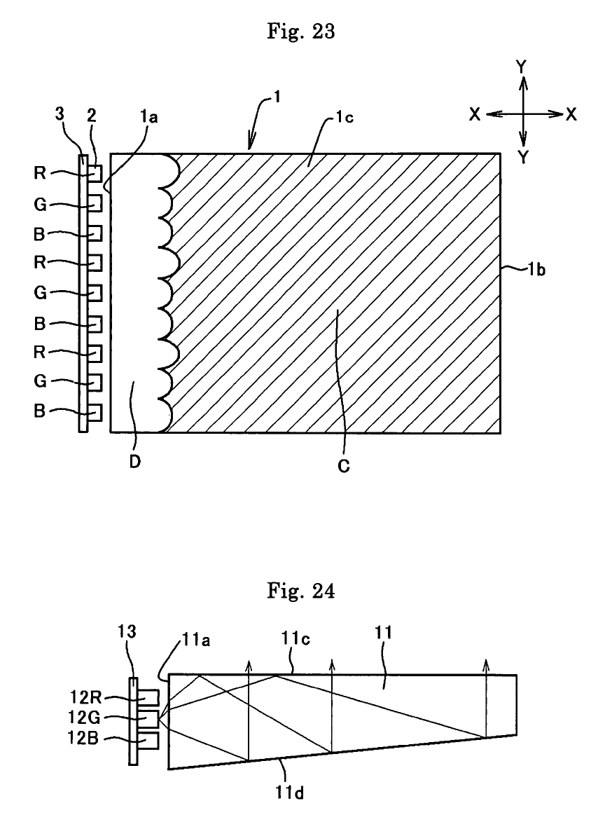

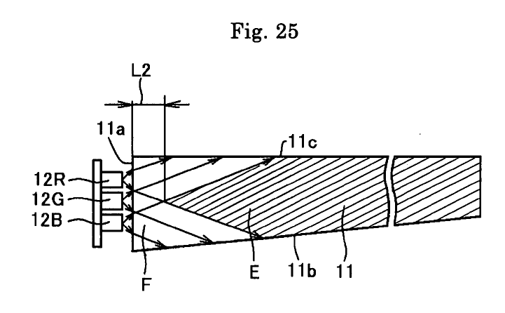

FIG. 19 shows a light guide plate 121 according to a still further embodiment.

The light guide plate 121 has on a light-receiving surface 121a thereof groove-shaped light-diffusing surfaces 122a extending in the width direction W of the light-receiving surface 121a and groove-shaped light-diffusing surfaces 122b extending in the vertical (thickness) direction T of the light-receiving surface 121a. The light-diffusing surfaces 122a and 122b are arranged to intersect each other in a mesh pattern. The light-diffusing surfaces 122a diffuse light from the LEDs in the thickness direction T, and the light-diffusing surfaces 122b diffuse light from the LEDs in the width direction W. The light source unit 63 is substantially the same as that shown in FIGS. 9 and 10.

In the foregoing, the light guide plate and backlight unit according to the present invention have been described with regard to various examples. All these examples allow mixing of red, green and blue colors of light to start from a region very close to the light-receiving surface of the light guide plate and hence enable light with minimized color irregularity to exit from the light-emitting surface. The light guide plate and backlight unit of the present invention are effectively applicable not only to display devices provided with color filters but also to field-sequential color display devices wherein red, green and blue LEDs are sequentially turned on at high speed and the associated image display pixels on the liquid crystal display panel are opened synchronously with the turning on of the LEDs, thereby obtaining color images. The backlight unit according to the present invention is also usable in a projector (image projector) and allows projection of color images free from color irregularity. In the projected color images, dark red and green color tones are also obtainable. Thus, the color reproduction range can be expanded.

It should be noted that the present invention is not necessarily limited to the foregoing embodiments but can be modified in a variety of ways without departing from the gist of the present invention.

What is claimed is:

1. A backlight unit comprising:
a light guide plate having a light-emitting surface, an opposite surface opposite to said light-emitting surface, and a peripheral edge surface extending between peripheral edges of said light-emitting surface and said opposite surface, a part of said peripheral edge surface being a flat light-receiving surface substantially at a right angle to said light-emitting surface, said light-receiving surface having a plurality of concave or convex light-diffusing surfaces that introduce incident light into said light guide plate while diffusing it; and
a plurality of light-emitting diodes disposed in a plane substantially at right angles to both said light-receiving surface and said light-emitting surface, said light-emitting diodes irradiating said light-receiving surface with respective lights of radiation spectra having different peak output wavelengths.

2. The backlight unit of claim 1, wherein said plurality of light-emitting diodes are arranged successively in a direction from said opposite surface toward said light-emitting surface and opposed to said light-receiving surface.

3. The backlight unit of claim 2, wherein said plurality of light-emitting diodes are disposed along an axis inclined with respect to said light-receiving surface in said plane and opposed to said light-receiving surface.

4. The backlight unit of claim 2, wherein at least two of said plurality of light-emitting diodes are disposed at different distances from said light-receiving surface.

5. The backlight unit of claim 1, wherein said light-diffusing surfaces diffuse light in a thickness direction of said light guide plate.

6. The backlight unit of claim 5, wherein said light-diffusing surfaces are provided along mutually parallel imaginary lines extending in a width direction of said light-receiving surface.

7. The backlight unit of claim 6, wherein said light-diffusing surfaces are provided continuously or discontinuously along said imaginary lines.

8. The backlight unit of claim 5, wherein said light-diffusing surfaces have a substantially semicircular or triangular cross-section.

9. The backlight unit of claim 5, wherein said light-diffusing surfaces include a plurality of mutually parallel first elongated surfaces having a concave cross-section and a plurality of mutually parallel second elongated surfaces having a concave cross-section, said second elongated surfaces intersecting said first elongated surfaces.

10. The backlight unit of claim 1, wherein said plurality of light-emitting diodes are mounted on respective substrates.

11. The backlight unit of claim 1, wherein said plurality of light-emitting diodes include light-emitting diodes having peak output wavelengths in a red region, a green region, and a blue region, respectively.

12. The backlight unit of claim 1, wherein said plurality of light-emitting diodes include whitish light-emitting diodes that are blue light-emitting diodes coated with a fluorescent material.

13. The backlight unit of claim 1, wherein said light guide plate comprises a plurality of split light guide plates that are tabular and stacked in a direction from said opposite surface toward said light-emitting surface.

14. The backlight unit of claim 13, wherein respective surfaces of said split light guide plates that form the light-receiving surface of said light guide plate are in a same plane.

15. The backlight unit of claim 13, wherein said plurality of light-emitting diodes are disposed to correspond respectively to said split light guide plates.

16. A display device comprising:
said backlight unit of claim 1; and
a liquid crystal display panel disposed adjacent to the light-emitting surface of said backlight unit.
